(19) United States
(12) Patent Application Publication
(10) Pub. No.: US 2026/0369465 A1
(43) Pub. Date: Nov. 19, 2026

(54) TRANSFORMER AND DISPLAY DEVICE

(71) Applicant: LG INNOTEK CO., LTD., Seoul (KR)

(72) Inventors: Inseok KANG, Seoul (KR); Sunyoung YU, Seoul (KR)

(21) Appl. No.: 19/126,118

(22) PCT Filed: Nov. 14, 2023
(86) PCT No.: PCT/KR2023/018299

§ 371 Date: Apr. 30, 2025

(30) Foreign Application Priority Data
Nov. 18, 2022 (KR) 10-2022-0155253

(51) Int. Cl. H01F 27/32; H01F 27/06; H01F 27/24; H01F 27/28; H01F 27/29; H01F 27/33; H01F 30/10

(52) U.S. Cl. CPC H01F 27/325; H01F 27/24; H01F 27/2847; H01F 27/29; H01F 27/33; H01F 30/10; H01F 27/065

(57) ABSTRACT

A transformer of an embodiment may comprise: a core part which includes two outer legs and a mid-leg disposed between the two outer legs; and a coil part which includes a primary coil portion and a secondary coil portion, a part of the primary coil portion and the secondary coil portion being disposed in the core part, wherein: at least a part of the secondary coil portion is arranged between the two outer legs and the primary coil portion in a first direction; a short-axis portion of the primary coil portion is arranged to be spaced a predetermined first distance apart from the mid-leg in a second direction intersecting the first direction; a long-axis portion of the primary coil portion is arranged to be spaced a predetermined second distance apart from the mid-leg in the first direction; and the first distance is greater than the second distance.

### TECHNICAL FIELD

The present disclosure relates to a transformer and a display device.

### BACKGROUND ART

Transformers are used in power supply units of electronic devices, for example, display devices.

Recently, as display devices have become larger and slimmer, power supply units are required to be miniaturized while maintaining high power density and high efficiency characteristics.

As the switching frequency increases, the transformer may be miniaturized; however, miniaturization of the transformer leads to a reduction in heat dissipation area, which results in losses in the coil and core of the transformer and increases heat generation. For example, when the transformer is driven at a frequency of 100 kHz or higher, the skin effect and proximity effect increase losses in the coil and core of the transformer, thereby increasing heat generation in the coil and core.

Meanwhile, a conventional transformer is configured such that a primary coil is wound around the core to prevent a gap from being formed between the primary coil and the core on a plane.

This winding structure of the primary coil in the conventional transformer causes heat generated in the primary coil to spread to the core, thereby increasing heat generation, and also makes it difficult for the heat to be effectively dissipated to the outside.

In addition, in the conventional transformer, insulation breakdown occurs due to the failure to secure a sufficient insulation distance between the primary coil and the core.

Also, in the conventional transformer, overcurrent occurs in the primary coil that is in contact with a short-axis portion of the core (e.g., a rounded portion), resulting in insulation breakdown.

Furthermore, in the conventional transformer, noise is generated due to vibration of the primary coil caused by current flow.

### DISCLOSURE

### Technical Problem

The present disclosure provides a transformer having a new structure that may be miniaturized while addressing the above problems of heat generation, insulation breakdown, and noise generation associated with the conventional transformer.

The technical tasks of the present disclosure are not limited to the above-mentioned technical tasks, and other technical tasks not mentioned herein will be clearly understood by those skilled in the art from the following description.

### Technical Solution

A transformer according to an embodiment may include a core unit including two outer legs and a center leg disposed between the two outer legs and a coil unit including a primary coil unit and a secondary coil unit, a portion of the primary coil unit and a portion of the secondary coil unit being disposed inside the core unit, wherein at least a portion of the secondary coil unit may be disposed between the two outer legs and the primary coil unit in a first direction, the primary coil unit may include a short-axis portion spaced apart from the center leg by a predetermined first distance in a second direction intersecting the first direction, the primary coil unit may include a long-axis portion spaced apart from the center leg by a predetermined second distance in the first direction, and the first distance may be greater than the second distance.

The length of a long-axis portion of the center leg may be less than the length of a long-axis portion of the core unit, and a short-axis portion of the center leg may have a first width. The first distance may be in a range of 0.5 times to 1 times the first width.

The second distance may be in a range of 0.45 times to 0.145 times the first width.

A minimum spacing distance between any one of the two outer legs and the secondary coil unit may be set to a predetermined third distance, and the third distance may be less than the first distance and greater than the second distance.

The third distance may be in a range of 0.145 times to 0.205 times the first width.

The primary coil unit may include a coil wound spirally, and the secondary coil unit may include a first plate and a second plate. The second plate may be disposed on the first plate in a third direction intersecting the first direction and the second direction.

Each of the first plate and the second plate may form an open turn in the first direction and the second direction. One end of each of the first plate and the second plate may include a first bent portion and a second bent portion connected to the first bent portion, and the other end of each of the first plate and the second plate may include a third bent portion and a fourth bent portion connected to the third bent portion.

A terminal portion may be disposed at an end of the second bent portion of each of the first plate and the second plate, and a terminal portion may be disposed at an end of the fourth bent portion of each of the first plate and the second plate.

The transformer may further include a bobbin disposed inside the core unit, and the bobbin may be disposed between the primary coil unit and the two outer legs.

A display device according to an embodiment may include a circuit board having the transformer disposed thereon.

### Advantageous Effects

The transformer according to the embodiment of the present disclosure may alleviate the heat generation problem of the conventional transformer, and may secure an insulation distance between a coil unit and a core unit of the transformer, thereby improving insulation performance and increasing the withstand voltage of the transformer.

### DESCRIPTION OF DRAWINGS

FIG. 1 is a perspective view showing the exemplary configuration of a transformer according to an embodiment.

FIG. 2 is a plan view showing the exemplary configuration of the transformer according to the embodiment in FIG. 1.

FIG. 3 is a perspective view showing the rear surface of the transformer according to the embodiment in FIG. 1.

FIG. 4 is a plan view showing the rear surface of the transformer according to the embodiment in FIG. 1.

FIG. 5 is a view showing a first side surface of the exemplary configuration of the transformer according to the embodiment in FIG. 1.

FIG. 6 is a view showing a second side surface of the exemplary configuration of the transformer according to the embodiment in FIG. 1.

FIG. 7 is a view showing a transformer according to an embodiment.

FIG. 8 is a view for explaining spacing distances between the components of the transformer on a plane according to an embodiment.

FIG. 9 is a view for explaining spacing distances between the components of the transformer on a plane according to an embodiment.

FIG. 10 is a view showing examples of the shape of a center leg of a core unit according to an embodiment.

### BEST MODE

The present disclosure may make various changes and have various embodiments, and specific embodiments are illustrated and described in the drawings. However, this is not intended to limit the present disclosure to a specific embodiment, and should be understood to include all changes, equivalents, or substitutes included in the spirit and technical scope of the present disclosure.

The suffixes “module” and “unit” used in this specification are only used for denominative distinction between elements, and should not be construed as presuming that the terms are physically and chemically distinguished or separated or may be distinguished or separated in that way.

Although terms including ordinal numbers, such as “first”, “second”, etc., may be used herein to describe various elements, the elements are not limited by these terms. These terms are only used to distinguish one element from another.

The term “and/or” is used to include any combination of a plurality of items that are the subject matter. For example, “A and/or B” inclusively means all three cases such as “A”, “B”, and “A and B”.

It will be understood that when a component is referred to as being “connected to” or “coupled to” another component, it may be directly connected to or coupled to another component, or intervening components may be present.

In the description of the embodiments, it will be understood that when an element, such as a layer (film), a region, a pattern or a structure, is referred to as being “on” or “under” another element, such as a substrate, a layer (film), a region, a pad or a pattern, the term “on” or “under” means that the element is directly on or under another element or is formed such that an intervening element may also be present. In addition, it will also be understood that criteria of “on” or “under” is on the basis of the drawing for convenience unless otherwise defined due to the characteristics of each of components or the relationship therebetween. The term “on” or “under” is used only to indicate the relative positional relationship between components and should not be construed as limiting the actual positions of the components. For example, the phrase “B on A” merely indicates that B is illustrated in the drawing as being located on A, unless otherwise defined or unless A must be located on B due to the characteristics of A or B. In an actual product, B may be located under A, or B and A may be disposed in a leftward-rightward direction.

In addition, the thickness or size of a layer (film), a region, a pattern, or a structure shown in the drawings may be exaggerated, omitted, or schematically drawn for the clarity and convenience of explanation, and may not accurately reflect the actual size.

The terminology used herein is for the purpose of describing particular embodiments only and is not intended to be limiting of exemplary embodiments of the disclosure. As used herein, the singular forms are intended to include the plural forms as well, unless the context clearly indicates otherwise. It will be further understood that the terms “include” or “have”, when used herein, specify the presence of stated features, integers, steps, operations, elements, components, or combinations thereof, but do not preclude the presence or addition of one or more other features, integers, steps, operations, elements, components, or combinations thereof.

Unless defined otherwise, all terms used herein, including technical or scientific terms, have the same meanings as commonly understood by one of ordinary skill in the art to which the present disclosure belongs. Terms such as those defined in commonly used dictionaries should be interpreted as having meanings consistent with the meanings in the context of the related art, and unless explicitly defined in this application, the terms should not be interpreted as having ideal or excessively formal meanings.

In addition, considering that a transformer related to the embodiments is mounted on a circuit board of a display device, the thickness (or the vertical height) of the transformer according to the present disclosure for contributing to slimness of the display device may be 14 mm or less, more specifically 12 mm or less, and even more specifically 10 mm or less, from the upper surface of the circuit board.

Hereinafter, the embodiment of the present disclosure will be described in detail with reference to the accompanying drawings.

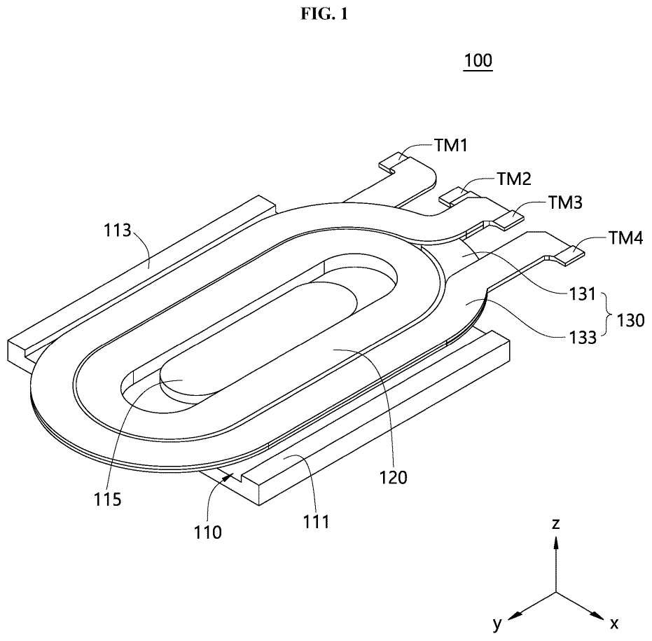

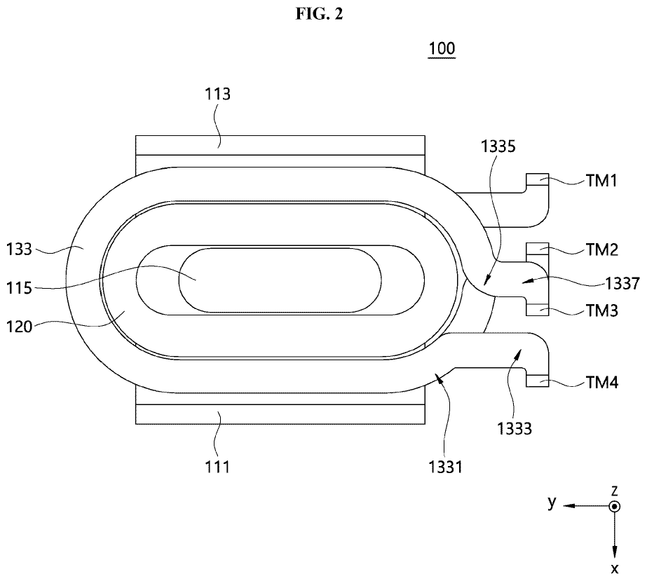

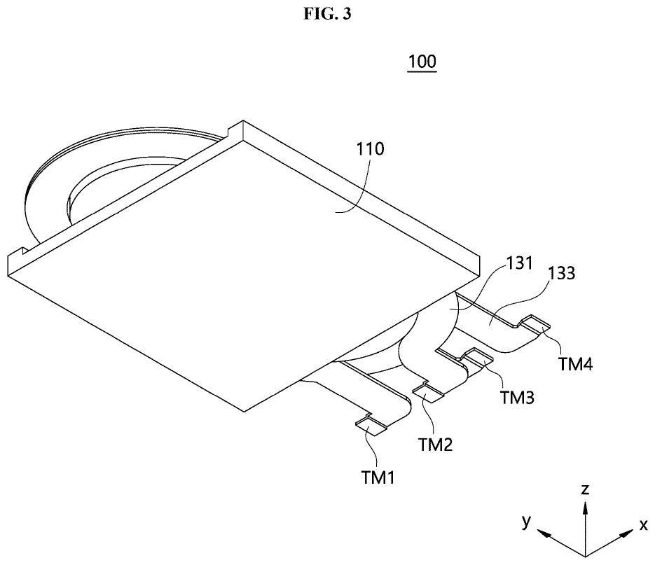

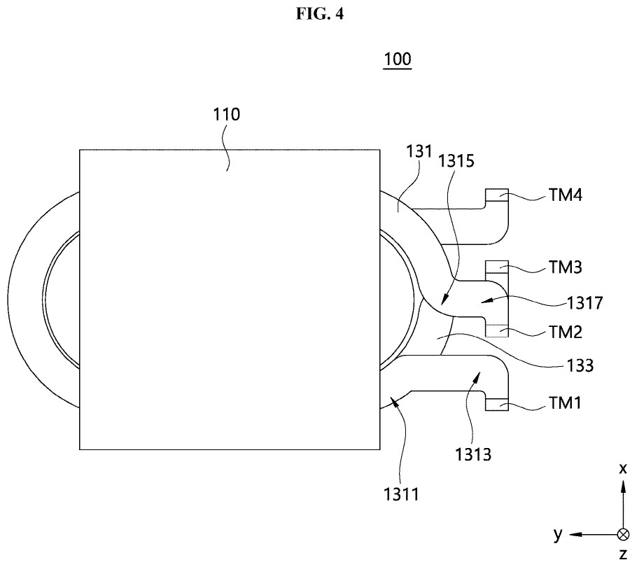

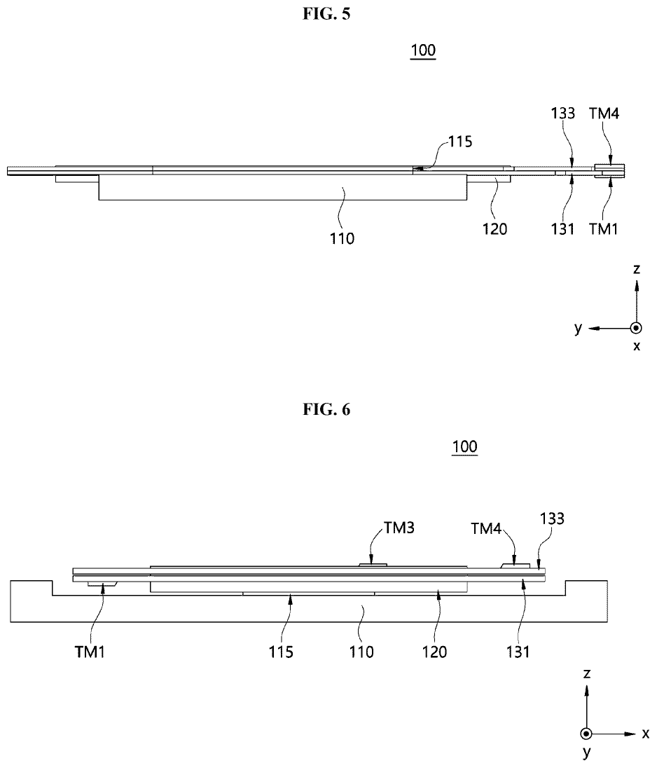

FIG. 1 is a perspective view showing the exemplary configuration of a transformer according to an embodiment. FIG. 2 is a plan view showing the exemplary configuration of the transformer according to the embodiment in FIG. 1. FIG. 3 is a perspective view showing the rear surface of the transformer according to the embodiment in FIG. 1. FIG. 4 is a plan view showing the rear surface of the transformer according to the embodiment in FIG. 1. FIG. 5 is a view showing a first side surface of the exemplary configuration of the transformer according to the embodiment in FIG. 1 (e.g., a side view in an x-axis direction on an x-y axis plane). FIG. 6 is a view showing a second side surface of the exemplary configuration of the transformer according to the embodiment in FIG. 1 (e.g., a side view in a y-axis direction on the x-y axis plane).

Referring to FIGS. 1 to 6, the transformer 100 may include a core unit 110 and a coil unit 120 and 130.

The core unit 110 may have the characteristics of a magnetic circuit and may act as a path for magnetic flux.

The core unit 110 may be disposed at a lower side of the transformer 100.

The core unit 110 may include a body portion having a planar shape and a plurality of leg portions 111, 113, and 115 protruding from the body portion in a thickness direction (e.g., z-axis direction) and extending in a predetermined direction. The plurality of leg portions 111, 113, and 115 may include two outer legs 111 and 113 extending in one axis direction (e.g., y-axis direction) on a plane and spaced apart from each other in another axis direction (e.g., x-axis direction) and a center leg 115 disposed between the two outer legs 111 and 113.

The coil unit 120 and 130 may include a primary coil unit 120 and a secondary coil unit 130.

The primary coil unit 120 may include a coil. Hereinafter, the primary coil unit 120 may also be referred to as a coil 120.

For example, the wire of the coil 120 may be formed as an enamel wire (USTC wire) wrapped by a fiber yarn, a Litz wire, a triple insulated wire (TIW), or a triple insulated Litz wire.

The coil 120 may be in the form of a winding spirally wound by one or more turns.

The coil 120 may be disposed on a portion of the upper end of the body portion of the core unit 110 so as to be disposed between the center leg 115 of the core unit 110 and the secondary coil unit 130 on a plane (e.g., x-y axis plane).

The secondary coil unit 130 may include a first plate 131 and a second plate 133 including a planar shape.

For example, the first plate 131 and the second plate 133 may include a conductive metal (e.g., copper or aluminum).

The first plate 131 and the second plate 133 may have planar shapes that are laterally symmetrical to each other on a plane (e.g., x-y axis plane).

For example, the first plate 131 may form one open turn on a plane (e.g., x-y axis plane). One end of the first plate 131 may include a first bent portion 1311 and a second bent portion 1313, and the other end thereof may include a third bent portion 1315 and a fourth bent portion 1317.

The second bent portion 1313 and the fourth bent portion 1317 may be bent at a first angle and may extend toward the outer leg 113 on a plane (e.g., x-y axis plane).

A terminal portion TM1 may be disposed at an end of the second bent portion 1313. In addition, a terminal portion TM2 may be disposed at an end of the fourth bent portion 1317.

In addition, the second plate 133 may form one open turn on a plane (e.g., x-y axis plane). One end of the second plate 133 may include a first bent portion 1331 and a second bent portion 1333, and the other end thereof may include a third bent portion 1335 and a fourth bent portion 1337.

The second bent portion 1333 and the fourth bent portion 1337 may be bent at a second angle and may extend toward the outer leg 111 on a plane (e.g., x-y axis plane). For example, the second angle may differ from the first angle by 180 degrees.

A terminal portion TM4 may be disposed at an end of the second bent portion 1333. In addition, a terminal portion TM3 may be disposed at an end of the fourth bent portion 1337.

The secondary coil unit 130, i.e., the first plate 131 and the second plate 133, may be disposed on a portion of the upper end of the body portion of the core unit 110 so as to be disposed between the two outer legs 111 and 113 of the core unit 110 and the coil 120 on a plane (e.g., x-y axis plane).

The first plate 131 and the second plate 133 may be aligned and stacked with respect to the center leg 115 of the core unit 110.

For example, the first plate 131 and the second plate 133 may be disposed such that the center leg 115 is located at the center of the turn of each of the first plate 131 and the second plate 133 on a plane (e.g., x-y axis plane). Furthermore, the first plate 131 may be disposed on the upper end of the body portion of the core unit 110, and the second plate 133 may be disposed on the upper end of the first plate 131.

For example, referring to FIGS. 1 to 6, when the core unit 110 has a first length in one axis direction (e.g., y-axis direction) and a second length in another axis direction (e.g., x-axis direction) on a plane (e.g., x-y axis plane), the maximum length of the coil 120 in one axis direction on the plane may be a third length that is greater than the first length, and the maximum length of the coil 120 in the other axis direction on the plane may be a fourth length that is less than the second length. In addition, the maximum length of the secondary coil unit 130, i.e., the first plate 131 and the second plate 133, in one axis direction (e.g., y-axis direction) on a plane (e.g., x-y axis plane) may be a fifth length that is greater than the third length, and the maximum length of the secondary coil unit 130 in another axis direction (e.g., x-axis direction) on the plane may be a sixth length that is less than the second length and greater than the fourth length.

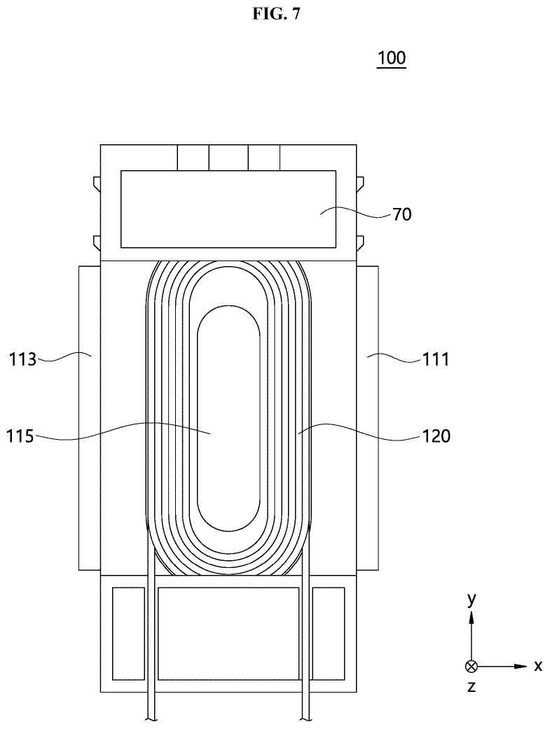

FIG. 7 is a view showing a transformer according to an embodiment.

Referring to FIG. 7, the transformer 100 may further include a bobbin 70 in addition to the above-described embodiment shown in FIGS. 1 to 6.

For example, the bobbin 70 may be disposed between the outer legs 111 and 113 of the core unit 110 and the coil 120 on a plane (e.g., x-y axis plane).

Meanwhile, although not shown, an insulating layer (not shown) may be disposed between the first plate 131 and the second plate 133 in addition to the above-described embodiment. For example, the insulating layer may include at least one material selected from the group consisting of ketone, a polyimide-based material, polyethylene terephthalate (PET), silicone, and an epoxy-based material.

Meanwhile, although not shown, the transformer 100 may further include a core unit (not shown) that is disposed at an upper side of the transformer 100 in addition to the above-described embodiments shown in FIGS. 1 to 7. For example, the core unit 110 disposed at the lower side and the core unit disposed at the upper side may be vertically symmetrical to each other or asymmetrical.

The transformer 100 according to the embodiments shown in FIGS. 1 to 7 may provide a structure that minimizes the contact area between the core unit 110 and the coil unit 120 and 130.

Such a structure of the transformer 100 that minimizes the contact area between the core unit 110 and the coil unit 120 and 130 may address the problem of increased heat generation in the conventional transformer, in which heat generated in the coil unit spreads to the core unit due to overlap between the core unit and the coil unit. Furthermore, according to the structure of the transformer 100 that minimizes the contact area between the core unit 110 and the coil unit 120 and 130, the transformer 100 according to the embodiment of the present disclosure may improve the withstand voltage of the transformer compared to the conventional transformer.

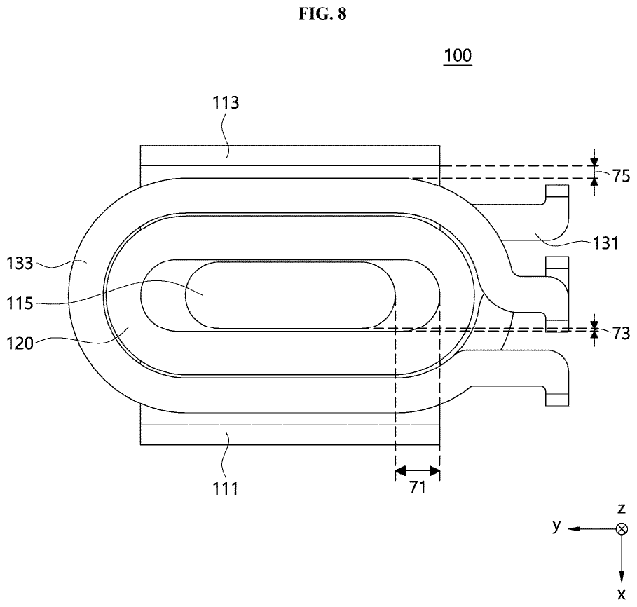

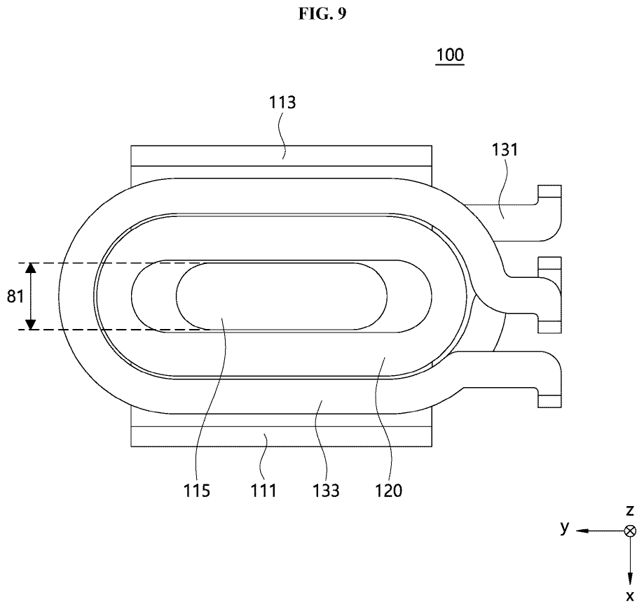

Hereinafter, an example of the structure of the transformer 100 for minimizing the contact area between the core unit 110 and the coil unit 120 and 130 will be described with reference to FIGS. 8 and 9.

FIG. 8 is a view for explaining spacing distances between the components of the transformer 100 on a plane (e.g., x-y axis plane) according to an embodiment. FIG. 9 is a view for explaining spacing distances between the components of the transformer 100 on a plane (e.g., x-y axis plane) according to an embodiment.

Referring to FIG. 8, the coil 120 may be in the form of a winding spirally wound around the center leg 115 of the core unit 110 on a plane (e.g., x-y axis plane) and may be spaced apart from the center leg 115 by predetermined distances 71 and 73 on a plane (e.g., x-y axis plane). For example, the coil 120 may be disposed on a portion of the upper end of the body portion of the core unit 110 such that an inner portion of the coil 120 formed in the winding shape and the center leg 115 (or an outer portion of the center leg 115) are spaced apart from each other by the predetermined distances 71 and 73.

For example, the predetermined distances 71 and 73 between the coil 120 and the center leg 115 may include a predetermined first distance 71 between the coil 120 and a short-axis portion (also referred to as a rounded portion) of the center leg 115 and a predetermined second distance 73 between the coil 120 and a long-axis portion of the center leg 115.

For example, the first distance 71 may be greater than the second distance 73.

Furthermore, the secondary coil unit 131 and 133 may be disposed on the upper end of the body portion of the core unit 110 such that each of the outer legs 111 and 113 is spaced apart from the secondary coil unit 131 and 133 by a predetermined third distance 75 on a plane (e.g., x-y axis plane).

For example, the first plate 131 and the second plate 133, in which open turns are formed on a plane (e.g., x-y axis plane), may be disposed on a portion of the upper end of the body portion of the core unit 110 such that outer portions of the turns of the first plate 131 and the second plate 133 are spaced apart from each of the outer legs 111 and 113 (or an inner portion of each of the outer legs 111 and 113) of the core unit 110 by the predetermined third distance 75.

When the short-axis portion of the coil is formed with a cornered geometry, it becomes vulnerable with respect to withstand voltage. Therefore, the short-axis portion of the coil 120 is formed with a rounded geometry, which is less vulnerable with respect to withstand voltage. However, the rounded portion exhibits greater heat generation than other portions. To address this issue, according to the present disclosure, the coil 120 may be disposed on a portion of the upper end of the body portion of the core unit 110 such that the coil 120 is spaced apart from the short-axis portion (also referred to as the rounded portion) of the center leg 115 by the predetermined first distance 71.

Furthermore, according to the manufacturing process, in a state in which the size of the core in another axis direction (e.g., x-axis direction) on a plane (e.g., x-y axis plane) is specified to a predetermined value, the core unit 110 and the coil unit 120 and 130 may be spaced apart from each other by a maximum possible distance. That is, the coil 120 and the long-axis portion of the center leg 115 may be spaced apart by the predetermined second distance 73, and the secondary coil unit 130 and the outer legs 111 and 113 may be spaced apart by the predetermined second distance 73.

Referring to FIG. 9, the spacing distance between the center leg 115 of the core unit 110 and the coil 120 may be determined based on the size of the center leg 115 of the core unit 110.

For example, the predetermined first distance 71 between the coil 120 and the short-axis portion (also referred to as the rounded portion) of the center leg 115 of the core unit 110 may be in a range of 0.5 times to 1 times the diameter (also referred to as a width) 81 of the short-axis portion of the center leg 115.

In addition, the predetermined second distance 73 between the coil 120 and the long-axis portion of the center leg 115 of the core unit 110 may be in a range of 0.045 times to 0.145 times the diameter 81 of the short-axis portion of the center leg 115.

In addition, the distance between the outer portions of the turns of the first plate 131 and the second plate 133 and each of the outer legs 111 and 113 of the core unit 110, i.e., the predetermined third distance 75, may be in a range of 0.145 times to 0.205 times the diameter 81 of the short-axis portion of the center leg 115.

For example, when the diameter 81 of the short-axis portion of the center leg on a plane (e.g., x-y axis plane) is 11 mm, the predetermined first distance 71 may be any value within a range of 5.5 mm to 11 mm, and the predetermined second distance 71 may be any value within a range of 0.5 mm to 1.6 mm.

As in the above-described embodiments shown in FIGS. 1 to 9, when the coil 120 and the center leg 115 of the core unit 110 are spaced apart by predetermined distances, the contact area between the coil 120 and the core unit 110 may be minimized, thereby facilitating the dissipation of heat generated by losses in the coil 120 and the core unit 110, and thus alleviating the heat generation problem of the conventional transformer.

In addition, as in the above-described embodiments shown in FIGS. 1 to 9, when the coil 120 and the center leg 115 of the core unit 110 are spaced apart by predetermined distances, an insulation distance between the coil 120 and the core unit 110 may be secured, thereby improving insulation performance and increasing withstand voltage, as shown in Table 1 below.

Table 1 shows measured withstand voltage data for the conventional transformer in which no distance is provided between the center leg 115 of the core unit 110 and the primary coil unit 120 and for the transformer 100 manufactured according to the above-described embodiments of the present disclosure.

TABLE 1

| | Conventional | Transformer of |
|---|---|---|
| Classification | Transformer | Present Disclosure |
| Primary Coil Unit - | 6.73 | 7.68 |
| Secondary Coil Unit | 6.1 | 8.12 |
| | 6.89 | 7.79 |
| | 6.38 | 7.67 |
| | 6.25 | 7.68 |
| Primary Coil Unit - | 6.52 | 8.12 |
| Core Unit | 6.57 | 8.06 |
| | 7.14 | 7.89 |
| | 6.82 | 8.35 |
| | 6.64 | 8.55 |

In addition, the transformer 100 according to the above-described embodiments may have an effect of reducing vibration-induced noise, as compared to the conventional transformer. For example, in general, when the transformer operates, noise is generated as the coil 120 and the core unit 110 vibrate. However, since the contact area between the coil 120 and the core unit 110 is reduced compared to the conventional transformer, the transformer 100 according to the above-described embodiments may have an effect of reducing vibration-induced noise.

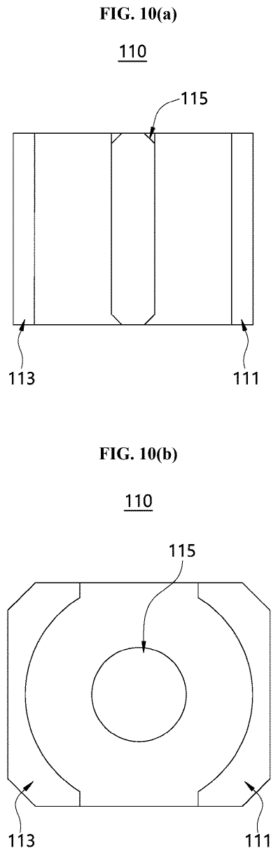

In addition, according to the above-described embodiments, since the coil 120 and the center leg 115 of the core unit 110 are spaced apart by predetermined distances, a degree of freedom in the shape of the center leg of the core unit 110 may also be secured. For example, center legs having various shapes may be implemented as shown in FIG. 10.

FIG. 10 is a view showing examples of the shape of the center leg of the core unit according to an embodiment.

Referring to FIG. 10, the shape of the center leg 115 of the core unit 110 may be formed in an octagonal shape, as shown in FIG. 10(a). In addition, the shape of the center leg 115 of the core unit 110 may be formed in a circular shape 115, as shown in FIG. 10(b).

While the present disclosure has been particularly shown and described with reference to exemplary embodiments thereof, these embodiments are only proposed for illustrative purposes, and do not restrict the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

### MODE FOR DISCLOSURE

Various embodiments have been described in the best mode for carrying out the disclosure.

### INDUSTRIAL APPLICABILITY

The transformer and the display device according to the embodiments may be used in power supply units of electronic devices, for example, display devices.

1. A transformer, comprising:
a core unit including two outer legs and a center leg disposed between the two outer legs; and
a coil unit including a primary coil unit and a secondary coil unit, a portion of the primary coil unit and a portion of the secondary coil unit being disposed inside the core unit,
wherein at least a portion of the secondary coil unit is disposed between the two outer legs and the primary coil unit in a first direction,
wherein the primary coil unit includes a short-axis portion spaced apart from the center leg by a predetermined first distance in a second direction intersecting the first direction,
wherein the primary coil unit includes a long-axis portion spaced apart from the center leg by a predetermined second distance in the first direction, and
wherein the first distance is greater than the second distance.

2. The transformer according to claim 1, wherein a length of a long-axis portion of the center leg is less than a length of a long-axis portion of the core unit,
wherein a short-axis portion of the center leg has a first width, and
wherein the first distance is in a range of 0.5 times to 1 times the first width.

3. The transformer according to claim 2, wherein the second distance is in a range of 0.045 times to 0.145 times the first width.

4. The transformer according to claim 3, wherein a minimum spacing distance between any one of the two outer legs and the secondary coil unit is set to a predetermined third distance, and
wherein the third distance is less than the first distance and greater than the second distance.

5. The transformer according to claim 4, wherein the third distance is in a range of 0.145 times to 0.205 times the first width.

6. The transformer according to claim 1, wherein the primary coil unit includes a coil wound spirally,
wherein the secondary coil unit includes a first plate and a second plate, and
wherein the second plate is disposed on the first plate in a third direction intersecting the first direction and the second direction.

7. The transformer according to claim 6, wherein each of the first plate and the second plate forms an open turn in the first direction and the second direction, and
wherein one end of each of the first plate and the second plate includes a first bent portion and a second bent portion connected to the first bent portion, and an other end of each of the first plate and the second plate includes a third bent portion and a fourth bent portion connected to the third bent portion.

8. The transformer according to claim 7, wherein a terminal portion is disposed at an end of the second bent portion of each of the first plate and the second plate, and
wherein a terminal portion is disposed at an end of the fourth bent portion of each of the first plate and the second plate.

9. The transformer according to claim 1, comprising a bobbin disposed inside the core unit,
wherein the bobbin is disposed between the primary coil unit and the two outer legs.

10. The transformer according to claim 7, wherein the second and fourth bent portions of the first plate are bent at a first angle, and
wherein the second and fourth bent portions of the second plate are bent at a second angle.

11. The transformer according to claim 10, wherein the second angle differs from the first angle by 180 degrees.

12. The transformer according to claim 1, wherein the core unit includes:
a body portion having a planar shape; and
a plurality of leg portions protruding from the body portion in a thickness direction, the plurality of leg portions including the two outer legs and the center leg.

13. The transformer according to claim 12, wherein the secondary coil unit includes:
a first plate disposed on an upper end of the body portion; and
a second plate disposed on an upper end of the first plate.

14. The transformer according to claim 13, wherein the first plate and the second plate have planar shapes that are laterally symmetrical to each other on a plane.

15. The transformer according to claim 13, wherein the core unit has a first length in one axis direction on a plane and a second length in another axis direction, and
wherein a maximum length of the primary coil unit in the one axis direction is a third length that is greater than the first length.

16. The transformer according to claim 15, wherein a maximum length of the primary coil unit in the other axis direction is a fourth length that is less than the second length.

17. The transformer according to claim 15, wherein a maximum length of each of the first plate and the second plate in the one axis direction is greater than the third length.

18. The transformer according to claim 16, wherein a maximum length of each of the first plate and the second plate in the other axis direction is less than the second length and greater than the fourth length.

19. The transformer according to claim 1, wherein a shape of the center leg is formed in an octagonal shape or in a circular shape.

20. A display device, comprising:
the transformer described in claim 1; and
a circuit board having the transformer disposed thereon.
